(19) United States
(12) Patent Application Publication
(10) Pub. No.: US 2015/0326927 A1
(43) Pub. Date: Nov. 12, 2015

(54) Portable Device Account Monitoring

(71) Applicant: THOMSON LICENSING, Issy de Moulineaux (FR)

(72) Inventor: James Richard Billmeyers, Mammoth Lakes, CA (US)

(21) Appl. No.: 14/662,776

(22) Filed: Mar. 19, 2015

Related U.S. Application Data
(60) Provisional application No. 61/969,296, filed on Mar. 24, 2014.

(51) Int. Cl. H04N 21/466; H04N 21/234; H04N 21/25; H04N 21/2668; H04N 21/258; H04N 21/45; H04N 21/81; H04N 21/442

(52) U.S. Cl. CPC H04N 21/4661; H04N 21/812; H04N 21/23424; H04N 21/44222; H04N 21/2668; H04N 21/25891; H04N 21/4532; H04N 21/252

(57) ABSTRACT

A method and apparatus for content recommendation in a video processing system. In particular, a method and apparatus for determining content enabled for playback on a first user account and a second user account. When a feature is used linking the two accounts, collected data is combined in order to make enhanced recommendations for each user based on the combined data from each user.

### FIELD OF THE INVENTION

The present invention relates to content recommendation in a media delivery system. In particular, the invention relates to a method and apparatus for analyzing preferences on multiple user accounts and making improved recommendations to each user in response to the combined analysis of the multiple accounts.

### BACKGROUND OF THE INVENTION

Digital content is ubiquitous today. Users have access to an enormous amount of digital content, such as music, audio/video programming, or text. While providers are benefiting from this distribution of content, protection of their property rights over this content and the control of unauthorized distribution is paramount to maintaining this revenue. Today users access digital content through an ever expanding array of devices, such as televisions, set top boxes, mobile phones, tablets, computers, alarm clocks, watches, automotive media players, and the like. On each device, a user must establish their right to access the content through various account numbers, usernames, passwords, tokens, and the like. This becomes burdensome, especially on devices that do not have easy interfaces to input these user identifiers. It would be desirable if a user could use one device to enable content to be played through a second device. This would permit a user, for example, to visit a friends house and play purchased media from their account on their friends display device.

It would be further advantageous if the service provider, now aware of a relationship between the two users, could examine the preferences of each user to make improved content recommendations.

### SUMMARY OF THE INVENTION

According to a general aspect, a method is provided for receiving a request to enable access to a first audio/video program by a second user, said first audio/video program being associated with a first user, advertising a second audio/video program to said first user in response to an analysis of data associated with said second user.

According to another general aspect, an apparatus is provided comprising a memory for storing a first user profile and a second user profile and a first audio/video program, a receiver for receiving a request to enable access to a first audio/video program by a second user, said first audio/video program being associated with a first user, a processor for determining a relationship between said first user and said first user profile, for determining a permission to enable said content for viewing for said first user in response to information within said first user profile, for enabling transmission of said first audio/video program to said second user, for determining a second audio/video program in response to information within said second user profile, and a transmitter for transmitting said first audio/video program to said second user and data relating to said second audio/video program to said first user.

### BRIEF DESCRIPTION OF THE DRAWINGS

These and other aspects, features and advantages of the present disclosure will be described or become apparent from the following detailed description of the preferred embodiments, which is to be read in connection with the accompanying drawings.

In the drawings, wherein like reference numerals denote similar elements throughout the views:

FIG. 1 is a block diagram of an exemplary system for delivering video content in accordance with the present disclosure;

FIG. 2 is a block diagram of an exemplary set-top box/digital video recorder (DVR) in accordance with the present disclosure;

FIG. 3A is an exemplary tablet and/or second screen device in accordance with an embodiment of the present disclosure;

FIG. 3B is an exemplary remote controller in accordance with an embodiment of the present disclosure;

FIG. 4 is a block diagram of an exemplary system for enabling digital rights management in accordance with the present disclosure;

FIG. 5 is an exemplary flowchart of the method in accordance with the present disclosure.

It should be understood that the drawing(s) is for purposes of illustrating the concepts of the disclosure and is not necessarily the only possible configuration for illustrating the disclosure.

### DETAILED DESCRIPTION OF THE PREFERRED EMBODIMENT

It should be understood that the elements shown in the figures may be implemented in various forms of hardware, software or combinations thereof. Preferably, these elements are implemented in a combination of hardware and software on one or more appropriately programmed general-purpose devices, which may include a processor, memory and input/output interfaces. Herein, the phrase “coupled” is defined to mean directly connected to or indirectly connected with through one or more intermediate components. Such intermediate components may include both hardware and software based components.

The present description illustrates the principles of the present disclosure. It will thus be appreciated that those skilled in the art will be able to devise various arrangements that, although not explicitly described or shown herein, embody the principles of the disclosure and are included within its spirit and scope.

All examples and conditional language recited herein are intended for instructional purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read only memory (“ROM”) for storing software, random access memory (“RAM”), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

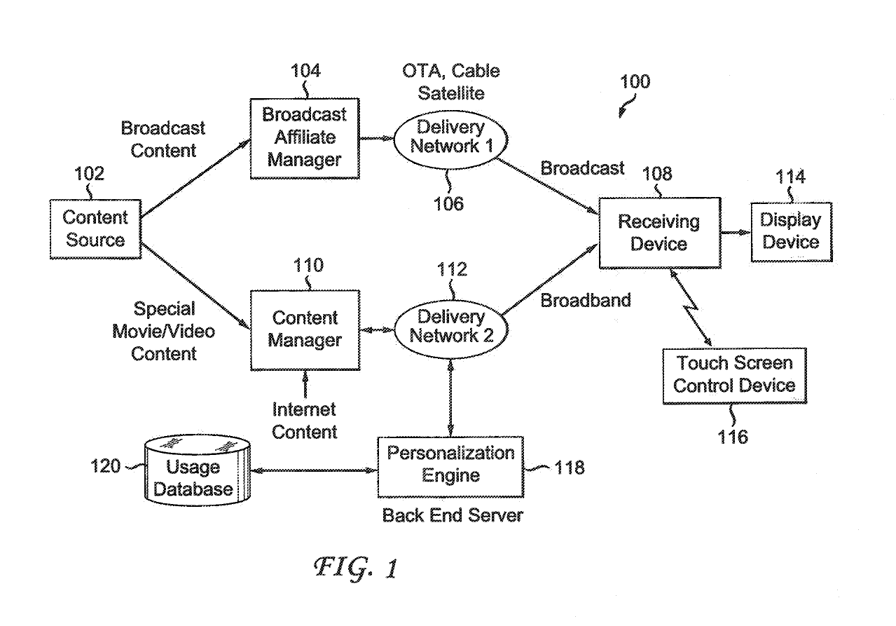

Turning now to FIG. 1, a block diagram of an embodiment of a system 100 for delivering content to a home or end user is shown. The content originates from a content source 102, such as a movie studio or production house. The content may be supplied in at least one of two forms. One form may be a broadcast form of content. The broadcast content is provided to the broadcast affiliate manager 104, which is typically a national broadcast service, such as the American Broadcasting Company (ABC), National Broadcasting Company (NBC), Columbia Broadcasting System (CBS), etc. The broadcast affiliate manager may collect and store the content, and may schedule delivery of the content over a delivery network, shown as delivery network 1 (106). Delivery network 1 (106) may include satellite link transmission from a national center to one or more regional or local centers. Delivery network 1 (106) may also include local content delivery using local delivery systems such as over the air broadcast, satellite broadcast, or cable broadcast. The locally delivered content is provided to a receiving device 108 in a user's home, where the content will subsequently be searched by the user. It is to be appreciated that the receiving device 108 can take many forms and may be embodied as a set top box/digital video recorder (DVR), a gateway, a modem, etc. Further, the receiving device 108 may act as entry point, or gateway, for a home network system that includes additional devices configured as either client or peer devices in the home network.

A second form of content is referred to as special content. Special content may include content delivered as premium viewing, pay-per-view, or other content otherwise not provided to the broadcast affiliate manager, e.g., movies, video games or other video elements. In many cases, the special content may be content requested by the user. The special content may be delivered to a content manager 110. The content manager 110 may be a service provider, such as an Internet website, affiliated, for instance, with a content provider, broadcast service, or delivery network service. The content manager 110 may also incorporate Internet content into the delivery system. The content manager 110 may deliver the content to the user's receiving device 108 over a separate delivery network, delivery network 2 (112). Delivery network 2 (112) may include high-speed broadband Internet type communications systems. It is important to note that the content from the broadcast affiliate manager 104 may also be delivered using all or parts of delivery network 2 (112) and content from the content manager 110 may be delivered using all or parts of delivery network 1 (106). In addition, the user may also obtain content directly from the Internet via delivery network 2 (112) without necessarily having the content managed by the content manager 110.

Several adaptations for utilizing the separately delivered content may be possible. In one possible approach, the special content is provided as an augmentation to the broadcast content, providing alternative displays, purchase and merchandising options, enhancement material, etc. In another embodiment, the special content may completely replace some programming content provided as broadcast content. Finally, the special content may be completely separate from the broadcast content, and may simply be a media alternative that the user may choose to utilize. For instance, the special content may be a library of movies that are not yet available as broadcast content.

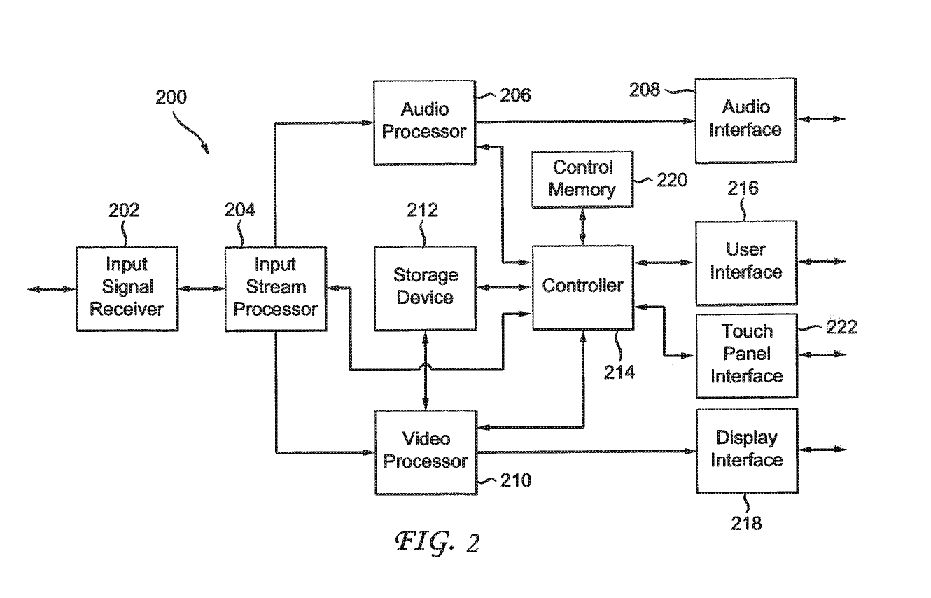

The receiving device 108 may receive different types of content from one or both of delivery network 1 and delivery network 2. The receiving device 108 processes the content, and provides a separation of the content based on user preferences and commands. The receiving device 108 may also include a storage device, such as a hard drive or optical disk drive, for recording and playing back audio and video content. Further details of the operation of the receiving device 108 and features associated with playing back stored content will be described below in relation to FIG. 2. The processed content is provided to a display device 114. The display device 114 may be a conventional 2-D type display or may alternatively be an advanced 3-D display.

The receiving device 108 may also be interfaced to a second screen such as a touch screen control device 116. The touch screen control device 116 may be adapted to provide user control for the receiving device 108 and/or the display device 114. The touch screen device 116 may also be capable of displaying video content. The video content may be graphics entries, such as user interface entries (as discussed below), or may be a portion of the video content that is delivered to the display device 114. The touch screen control device 116 may interface to receiving device 108 using any well known signal transmission system, such as infra-red (IR) or radio frequency (RF) communications and may include standard protocols such as infra-red data association (IRDA) standard, Wi-Fi, Bluetooth and the like, or any other proprietary protocols. Operations of touch screen control device 116 will be described in further detail below.

In the example of FIG. 1, system 100 also includes a back end server 118 and a usage database 120. The back end server 118 includes a personalization engine that analyzes the usage habits of a user and makes recommendations based on those usage habits. The usage database 120 is where the usage habits for a user are stored. In some cases, the usage database 120 may be part of the back end server 118. In the present example, the back end server 118 (as well as the usage database 120) is connected to the system 100 and accessed through the delivery network 2 (112). In an alternate embodiment, the usage database 120 and backend server 118 may be embodied in the receiving device 108. In a further alternate embodiment, the usage database 120 and back end server 118 may be embodied on a local area network to which the receiving device 108 is connected.

Turning now to FIG. 2, a block diagram of an embodiment of a receiving device 200 is shown. Receiving device 200 may operate similar to the receiving device described in FIG. 1 and may be included as part of a gateway device, modem, set-top box, or other similar communications device. The device 200 shown may also be incorporated into other systems including an audio device or a display device. In either case, several components necessary for complete operation of the system are not shown in the interest of conciseness, as they are well known to those skilled in the art. In one exemplary embodiment, the receiving device 200 may be a set top box coupled to a display device (e.g. television).

In the device 200 shown in FIG. 2, the content is received by an input signal receiver 202. The input signal receiver 202 may be one of several known receiver circuits used for receiving, demodulation, and decoding signals provided over one of the several possible networks including over the air, cable, satellite, Ethernet, fiber and phone line networks. The desired input signal may be selected and retrieved by the input signal receiver 202 based on user input provided through a control interface or touch panel interface 222. Touch panel interface 222 may include an interface for a touch screen device. Touch panel interface 222 may also be adapted to interface to a cellular phone, a tablet, a mouse, a high end remote or the like.

The decoded output signal is provided to an input stream processor 204. The input stream processor 204 performs the final signal selection and processing, and includes separation of video content from audio content for the content stream. The audio content is provided to an audio processor 206 for conversion from the received format, such as compressed digital signal, to an analog waveform signal. The analog waveform signal is provided to an audio interface 208 and further to the display device or audio amplifier. Alternatively, the audio interface 208 may provide a digital signal to an audio output device or display device using a High-Definition Multimedia Interface (HDMI) cable or alternate audio interface such as via a Sony/Philips Digital Interconnect Format (SPDIF). The audio interface may also include amplifiers for driving one more sets of speakers. The audio processor 206 also performs any necessary conversion for the storage of the audio signals.

The video output from the input stream processor 204 is provided to a video processor 210. The video signal may be one of several formats. The video processor 210 provides, as necessary, a conversion of the video content, based on the input signal format. The video processor 210 also performs any necessary conversion for the storage of the video signals.

A storage device 212 stores audio and video content received at the input. The storage device 212 allows later retrieval and playback of the content under the control of a controller 214 and also based on commands, e.g., navigation instructions such as fast-forward (FF) and rewind (RW), received from a user interface 216 and/or touch panel interface 222. The storage device 212 may be a hard disk drive, one or more large capacity integrated electronic memories, such as static RAM (SRAM), or dynamic RAM (DRAM), or may be an interchangeable optical disk storage system such as a compact disk (CD) drive or digital video disk (DVD) drive.

The converted video signal, from the video processor 210, either originating from the input or from the storage device 212, is provided to the display interface 218. The display interface 218 further provides the display signal to a display device of the type described above. The display interface 218 may be an analog signal interface such as red-green-blue (RGB) or may be a digital interface such as HDMI. It is to be appreciated that the display interface 218 will generate the various screens for presenting the search results (e.g., in a three dimensional grid, two dimensional array, and/or a shelf as will be described in more detail below).

The controller 214 is interconnected via a bus to several of the components of the device 200, including the input stream processor 204, audio processor 206, video processor 210, storage device 212, and a user interface 216. The controller 214 manages the conversion process for converting the input stream signal into a signal for storage on the storage device or for display. The controller 214 also manages the retrieval and playback of stored content. Furthermore, as will be described below, the controller 214 performs searching of content and the creation and adjusting of the grid, array and/or shelf display representing the content, either stored or to be delivered via the delivery networks, described above.

The controller 214 is further coupled to control memory 220 (e.g., volatile or non-volatile memory, including RAM, SRAM, DRAM, ROM, programmable ROM (PROM), flash memory, electronically programmable ROM (EPROM), electronically erasable programmable ROM (EEPROM), etc.) for storing information and instruction code for controller 214. Control memory 220 may store instructions for controller 214. Control memory 220 may also store a database of elements, such as graphic elements containing content. The database may be stored as a pattern of graphic elements, such as graphic elements containing content, various graphic elements used for generating a displayable user interface for display interface 218, and the like. Alternatively, the memory may store the graphic elements in identified or grouped memory locations and use an access or location table to identify the memory locations for the various portions of information related to the graphic elements. Additional details related to the storage of the graphic elements will be described below. Further, the implementation of the control memory 220 may include several possible embodiments, such as a single memory device or, alternatively, more than one memory circuit communicatively connected or coupled together to form a shared or common memory. Still further, the memory may be included with other circuitry, such as portions of bus communications circuitry, in a larger circuit.

Optionally, controller 214 can be adapted to extract metadata, criteria, characteristics or the like from audio and video media by using audio processor 206 and video processor 210, respectively. That is, metadata, criteria, characteristics or the like that is contained in the vertical blanking interval, auxiliary data fields associated with video, or in other areas in the video signal can be harvested by using the video processor 210 with controller 214 to generate metadata that can be used for functions such as generating an electronic program guide having descriptive information about received video, supporting an auxiliary information service, and the like. Similarly, the audio processor 206 working with controller 214 can be adapted to recognize audio watermarks that may be in an audio signal. Such audio watermarks can then be used to perform some action such as the recognition of the audio signal, provide security which identifies the source of an audio signal, or perform some other service. Furthermore, metadata, criteria, characteristics or the like, to support the actions listed above can come from a network source which are processed by controller 214.

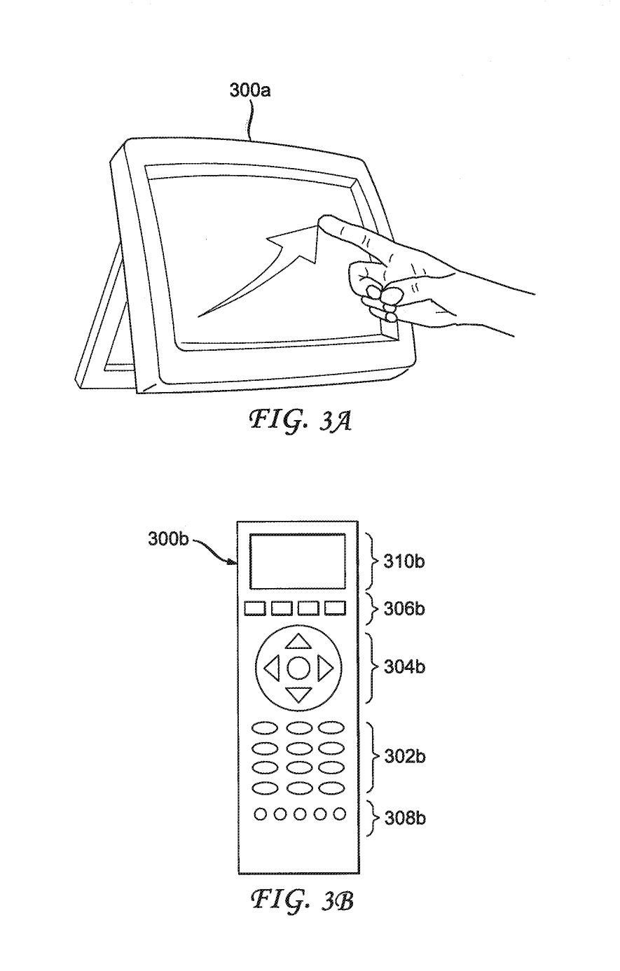

FIGS. 3A and 3B represent two exemplary input devices, 300a and 300b (hereinafter referred to collectively as input device 300), for use with the system described in FIGS. 1 and 2. The user input device 300 enables operation of and interaction with the user interface process according to invention principles. The input device may be used to initiate and/or select any function available to a user related to the acquisition, consumption, access and/or modification of multimedia content. FIG. 3A represents one exemplary tablet or touch panel input device 300a (which is the same as the touch screen device 116 shown in FIG. 1 and/or is an integrated example of media device 108 and touch screen device 116). The touch panel device 300a may be interfaced via the user interface 216 and/or touch panel interface 222 of the receiving device 200 in FIG. 2. The touch panel device 300a allows operation of the receiving device or set top box based on hand movements, or gestures, and actions translated through the panel into commands for the set top box or other control device. This is achieved by the controller 214 generating a touch screen user interface including at least one user selectable image element enabling initiation of at least one operational command. The touch screen user interface may be pushed to the touch screen device 300a via the user interface 216 and/or the touch panel interface 222. In an alternative embodiment, the touch screen user interface generated by the controller 214 may be accessible via a webserver executing on one of the user interface 216 and/or the touch panel interface 222. The touch panel 300 may serve as a navigational tool to navigate the grid display. In other embodiments, the touch panel 300a will additionally serve as the display device allowing the user to more directly interact with the navigation through the grid display of content. The touch panel device 300a may be included as part of a remote control device 300b containing more conventional control functions such as activator and/or actuator buttons such as is shown in FIG. 3B. The touch panel 300a can also include at least one camera element and/or at least one audio sensing element.

In one embodiment, the touch panel 300a employs a gesture sensing controller or touch screen enabling a number of different types of user interaction. The inputs from the controller are used to define gestures and the gestures, in turn, define specific contextual commands. The configuration of the sensors may permit defining movement of a user's fingers on a touch screen or may even permit defining the movement of the controller itself in either one dimension or two dimensions. Two-dimensional motion, such as a diagonal, and a combination of yaw, pitch and roll can be used to define any three-dimensional motions, such as a swing. Gestures are interpreted in context and are identified by defined movements made by the user. Depending on the complexity of the sensor system, only simple one dimensional motions or gestures may be allowed. For instance, a simple right or left movement on the sensor as shown here may produce a fast forward or rewind function. In addition, multiple sensors could be included and placed at different locations on the touch screen. For instance, a horizontal sensor for left and right movement may be placed in one spot and used for volume up/down, while a vertical sensor for up and down movement may be placed in a different spot and used for channel up/down. In this way specific gesture mappings may be used. For example, the touch screen device 300a may recognize alphanumeric input traces which may be automatically converted into alphanumeric text displayable on one of the touch screen device 300a or output via display interface 218 to a primary display device.

The system may also be operated using an alternate input device 300b such as the one shown in FIG. 3B. The input device 300b may be used to interact with the user interfaces generated by the system and which are output for display by the display interface 218 to a primary display device (e.g. television, monitor, etc). The input device of FIG. 3B may be formed as a conventional remote control having a 12-button alphanumerical key pad 302b and a navigation section 304b including directional navigation buttons and a selector. The input device 300b may also include a set of function buttons 306b that, when selected, initiate a particular system function (e.g. menu, guide, DVR, etc). Additionally, the input device 300b may also include a set of programmable application specific buttons 308b that, when selected, may initiate a particularly defined function associated with a particular application executed by the controller 214. As discussed above, the input device may also include a touch panel 310b that may operate in a similar manner as discussed above in FIG. 3A. The depiction of the input device in FIG. 3B is merely exemplary and the input device may include any number and/or arrangement of buttons that enable a user to interact with the user interface process according to invention principles. Additionally, it should be noted that users may use either or both of the input devices depicted and described in FIGS. 3A and 3B simultaneously and/or sequentially to interact with the system.

In another embodiment, the user input device may include at least one of an audio sensor and a visual sensor. In this embodiment, the audio sensor may sense audible commands issued from a user and translate the audible commands into functions to be executed by the user. The visual sensor may sense the user(s) present and match user information of the sensed user(s) to stored visual data in the usage database 120 in FIG. 1. Matching visual data sensed by the visual sensor enables the system to automatically recognize the user(s) present and retrieve any user profile information associated with those user(s). Additionally, the visual sensor may sense physical movements of at least one user present and translate those movements into control commands for controlling the operation of the system. In this embodiment, the system may have a set of pre-stored command gestures that, if sensed, enable the controller 214 to execute a particular feature or function of the system. An exemplary type of gesture command may include the user waving their hand in a rightward direction which may initiate a fast forward command or a next screen command or a leftward direction which may initiate a rewind or previous screen command depending on the current context. This description of physical gestures able to be recognized by the system is merely exemplary and should not be taken as limiting. Rather, this description is intended to illustrate the general concept of physical gesture control that may be recognized by the system and persons skilled in the art could readily understand that the controller may be programmed to specifically recognize any physical gesture and allow that gesture to be tied to at least one executable function of the system.

In the context of the present system, the input device 300 enables the user to interact with a plurality user interfaces. The user interfaces contain different types of user selectable image elements. The user selectable image element may be representative of at least one type of media object that is included in the media content being received and output for display. As used herein, the term multimedia content refers to audio-video data that may be acquired or otherwise received and which may be at least one of output for display to a user and stored in a storage device for later viewing. The multimedia content may be received live, in real-time, or may be a pre-recorded. Multimedia content is associated with an auxiliary media data file. The auxiliary media data file includes information describing at least one media object included in the multimedia content. The information in the auxiliary media data file includes position information describing the various positions of the respective media object within the multimedia content. It should be understood that the auxiliary media data file may be an actual file that is communicated from a content provider to the receiving device. Alternatively, the auxiliary media data file may be generated by the receiver device in response to receiving a data stream that includes auxiliary media data. The information may also include position description information describing each position of the media object. The information may also include media object description information that describes at least one characteristic of the media object. Additionally, the term media object refers to an item associated with the multimedia content, the selection of which results in execution of a further action. A media object may include any item, person, background, location or any other element of the multimedia content that may be displayed to a user for selection thereof. The further action resulting from the selection of an exemplary media object may be at least one of (a) skipping to another location within the media content that also includes the media object; (b) generating of a further user interface including a list of at least one other position within the multimedia content that includes the selected media object; (c) generating a further user interface that includes a listing of auxiliary information associated with the selected media object. Thus, by presenting media objects within a user interface, the user consuming the multimedia content can quickly navigate to additional positions of the multimedia content that also include the same media object. For example, the multimedia object may be a motion picture and each of the actors in the motion picture may be represented as individual media objects. A selectable image element representing each media object (actor) may be presented within a user interface and, in response to selection thereof, result in automatic skipping within the multimedia content to a subsequent position therein where that actor is once again shown (e.g. a subsequent scene). Alternatively, selection of the media object representing an actor may generate a further user interface including a list of at least one other position within the multimedia content where that media object (e.g. actor) is shown (e.g. a list of additional scenes in the motion picture that include that actor).

In the following description, it should be understood that all user interfaces including user selectable image elements may be generated by the controller 214 of FIG. 2 and output to the user via at least one of the use interface 216, the display interface 218 and/or the touch panel interface 222. Additionally, the interaction with the user interfaces generated by the controller 214 may be accomplished via the input device 300a and/or 300b such that any selection of an image element will be received and processed by the controller 214 resulting in one of (a) updating the currently displayed user interface in response to the data selected or entered by the user; and (b) generating a new user interface in response to the data selected or entered by the user.

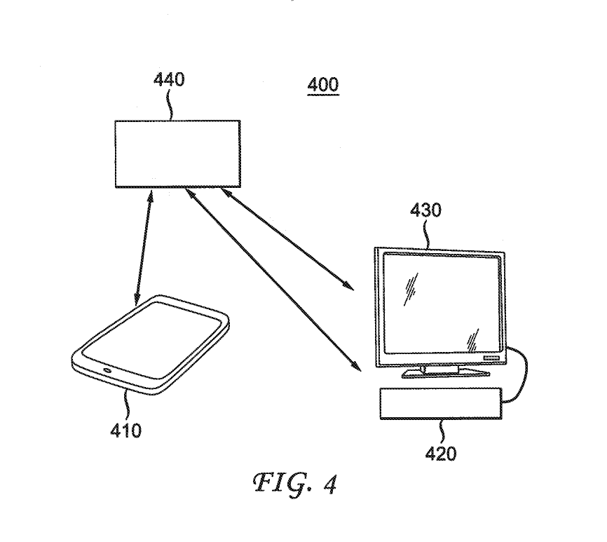

Turning now to FIG. 4, a diagram of an exemplary embodiment of a system diagram 400 of a portable media device 410 and a reception device 420 is shown. FIG. 4 shows a portable media device 410, such as a mobile phone, a reception device 420, such as a television set top box, a television display device 430, and a wireless network access point 440, such as a WIFI router.

The problem of controlling digital content rights has become more cumbersome for both content providers and content consumers. A user must establish permissions for each device the content is desired to be consumed upon. The content provider must provide access to the content for each user from a growing number of devices, wherein the content provider may not know that a subscriber is the actual user of the device and any given moment. It would be advantageous if a user could establish permissions on one device and user those permissions to play the content on other devices. For example, a user with a mobile phone having all the users digital rights established could be used to satisfy account identification on a second device, such as a television. Thus, the user could watch content on a television without having to input account information on the television. This would be advantageous to the content providers also in that the provider could be relatively confident that a subscriber's mobile phone would frequently be with a subscriber and not with a third party.

The system 400 would further permit a subscriber to visit a remote location and have content that is linked to a first device be played back on a second device. For example, if a subscriber visits a friend, the subscriber could play digital content on the friend's television without having to provide account information on the friend's television. Permissions could further be based on both accounts. For example, if a premium subscriber visits a location of a basic subscriber, premium content could be enabled on the basic subscribers account while the premium subscriber's mobile device is proximate to the basic subscriber's device. The ability to play content on the basic subscriber's device will terminate if the proximity of the first device changes. Alternatively, a restriction could be applied that one basic content from a first subscriber could be played on the basic subscriber's device and the premium subscriber's premium content could be blocked from the basic subscriber's device.

When bringing a first portable device to the location of a second device, it is possible to have content played back which exists on the first device which is played out on the second device. The invention keeps track of the content that is played back from the first device on the second device so demographic and advertising information can be provided to a service provider/content provider. Establishing links between profiles of a first user and a second user may provide insight into preferences of each user. For example, if the first user is a regular viewer of action movies or popular music, it may indicate that the second user also has those interests. The frequency of contact between the users may further reinforce this assumption.

The proposed exemplary system would also aid in assigning digital rights to a single user. For example, if a user has digital rights to content established on a mobile device, such as a cellular phone, and this device is used to establish a connection with a display device. Thus, for a user to watch content on the display device, the mobile device must be proximate. The proximity of the mobile device may be established through a WIFI network or GPS sensor data. If the mobile device is not present, the user may be able to gain temporary access to the content by entering account information that may change for periodically, such as amount of last bill, or last pay per view movie purchased. Alternatively, the user may be asked account information that would not be desirable to share with others, such as last four digits of social insurance number.

An exemplary embodiment of the above described system is shown in FIG. 4. The exemplary system illustrates the operation between a portable media device 410 and a reception device 420, such as a set top box, a television, personal computer, media hub, and the like. Both the portable media device 410 and the reception device 420 are running the same or complementary applications permitting media be consumed on both the portable media device and the reception device independently.

An exemplary media delivery system provides media assets to be delivered in a digital form (downloaded/streamed/or a combination thereof) from a remote server for playback. The ability to consume (watch/record) content depends on an account that a user has with the media delivery system. A user may buy/rent/preview content from the media delivery system where the account of the user reflects the access privileges of the user when consuming such content. In the media delivery system, it is possible that the access privileges for a user are tied to a specific device as the portable media device 410. The reception device 420 likewise can have another user account associated with the reception device 420 where the content that can be consumed on the reception device 420 depend on the account tied to the reception device 420. For purposes of this exemplary embodiment, the account on the Portable Media Device 410 is called a visiting account and the account on the reception device 420 is called a home account, where each account has different media accessible through each device.

In the operation of both devices, it is expected at a user can bring a portable device 410 to the location in which the reception device 420 exists. Both devices can then communicate with each other through a wireless interface (RF/Bluetooth/802.11, and the like), where the media delivery middleware will recognize the access privileges of the portable media device 410, whereby content that is authorized to be played on the portable media device 410 can be enabled for playback through the reception device 420.

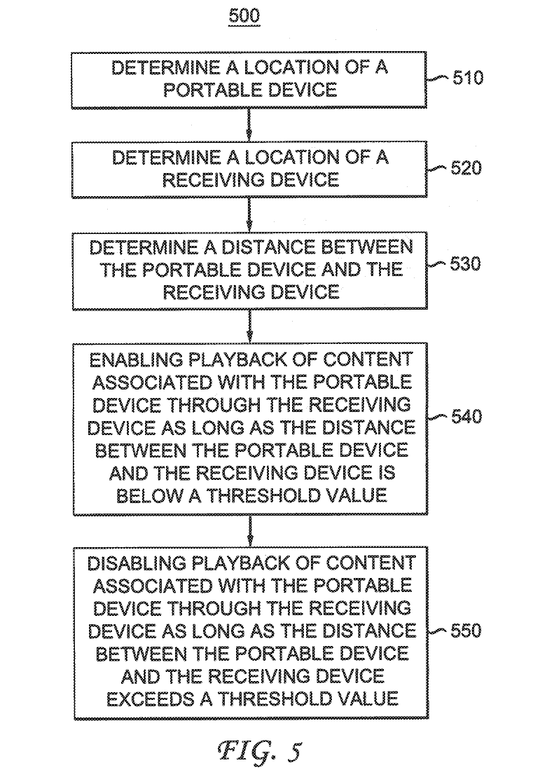

Turning now to FIG. 5, an exemplary flowchart 500 of the method of determining a geographic areas in which the device that is associated is shown. In an exemplary mode of operation, a value may be assigned to the visiting account which prescribes various geographic areas in which the portable media device 410 that is associated with the visiting account can be accessed for content playback.

At step 510, a determination is made by the media delivery system of the geographical location of the portable media device. The geographical value can be checked by using methodologies such as WI-FI location, GPS, or other means that can be used to determine a device's location physically. The physical location may be determined by the portable media device and transmitted to the media delivery system server. Alternatively, the physical location of the portable media device may be made by generating a short distance wireless or wired connection between the portable media device and the reception device.

At step 520, the system determines the location of the receiving device that can be used for playing back content from the portable device. This determination may be made in a similar manner to that of the portable media device. At step 530, the media deliver system determined a distance between the portable media device and the reception device. If the locations of the portable device and the receiving device are within an acceptable geographical location according to the corresponding accounts of both devices, a check is performed to determine the distance between both devices. This can be a check where both devices check themselves in with a remote server through a cellular or wire based network connection. This check can be performed on a periodic basis which can be modified in accordance with an encrypted algorithm.

The check of the distances can be performed by comparing GPS locations, checking a physical distance by using a locally enabled wireless connection of certain distance such as BLUEBOOTH, or other locale RF interface and the like. This check can be performed between the devices themselves. This distance information then can be reported to a remote server on a periodic basis. An optional embodiment has this check between the distances reported on an asynchronous basis in accordance with an algorithm that has parameters that are modified and only known to the portable and receiving device.

At step 540, the media delivery system enables playback of content associated with the portable device through the receiving device as long as the distance between the portable device and the receiving device is below a threshold value. If the distance between the two devices is within a certain threshold, the content privileges associated with the portable device will be temporarily enabled for the receiving device such that the content associated with the portable device can be played on the receiving device. Such content can be played from the portable device itself, enabled to be streamed from a remote server from the portable device to the receiving device, or the content can be streamed from a remote server to the receiving device itself.

At step 550, the media delivery system disables playback of content associated with the portable device through the receiving device once the distance between the portable device and the receiving device exceeds a threshold value. Content will be capable of being played on the remote device until the distance between the portable device and the receiving device exceeds a certain distance. Alternatively, the threshold value may be whether or not a wireless link can be established through the devices between a local RF interface such as BlueTooth, 802.11, and the like. If such a wireless link breaks off, the playback of content will cease on the receiving device.

When bringing a first portable device to the location of a second device, it is possible to have content played back which exists on the first device which is played out on the second device. The system keeps track of the content that is played back from the first device on the second device so demographic and advertising information can be provided to a service provider/content provider. The receiving device likewise can have another user account associated with the device, where the content that can be consumed on the device depend on the account tied to the receiving device. Typically, a content monitoring service only keeps track of content when it is played back on a particular device. The addressed service however addresses when content is played “through” a device or is used to enable the playback for content on a second device.

The information kept can be accomplished through software enabled on a device or through a monitoring service where the information kept track of is shown in Table I.

TABLE 1

| | Media | | | | |
|---|---|---|---|---|---|
| | Device | | Location | Percent- | Accounts |
| Media | used for | | of Media | age of | Used for |
| Device | Consump- | Media | Consump- | Media | Consump- |
| Source | tion | Consumed | tion | Consumed | tion |
| Device 1 | Device 2 | Rocky I - | Home | 100 | User 1. |
| | | Movie | | | User 2 |
| Device 1 | Device 1 | Expendables | Work | 75 | User 1 |
| Device 2 | Device 2 | Seinfeld | Home | 100 | User 2 |
| Device 1 | Device 2 | Beatles - | Home | 100 | User 1, |
| | | White | | | User 2 |
| | | Album | | | |

For this exemplary embodiment, the Media Device Source is the device in which a media file comes from, the Media Device used for Consumption is the device that is used to displaying (consuming) a piece of media, the Media Consumed is the media that was displayed, the Location of Media Consumption is where media was consumed, the Percentage of Media Consumed indicates how much (as a percentage) media was matched on the Media Device used for Consumption, the Accounts Used for Consumption indicates both the user account associated with the device that acts as the source of media and the account associated with the device that consumed such media. Using this information, advertisements can be shown which are keyed to the users associated with the consumption/source devices, instead of showing an advertisement that would apply only to the device that was used for consuming media. In addition, advertisements can be geared towards the location of where the media was consumed. That is, an advertisement for “home” would be different than the advertisement for “work”.

In an optional embodiment, a listing of content is shown where the list indicates what content can be output in what setting. For example, some content may only be viewable on a first device, multiple devices or may also be viewed on a second device on a platform associated with certain users, etc.

While the present invention has been described with reference to the preferred embodiments, it is apparent that various changes may be made in the embodiments without departing from the spirit and the scope of the invention, as defined by the appended claims.

1. A method comprising the steps of:
receiving a request to enable access to a first audio/video program by a second user, said first audio/video program being associated with a first user;
advertising a second audio/video program to said first user in response to an analysis of data associated with said second user.

2. The method of claim 2 wherein said second audio/video program is determined in response to a combined analysis of data associated with said first user and data associated with said second user.

3. The method of claim 1 wherein said second audio/video program is determined in response to a media purchase made by said second user.

4. The method of claim 1 wherein said second audio/video program is determined in response to a comparison of a viewing history of said first user and a viewing history of said second user.

5. The method of claim 1 wherein the first audio/video program includes data identifying said first user.

6. The method of claim 1 further comprising the step of updating a first user profile and a second user profile with a record of said first audio/video program.

7. An apparatus comprising:
a memory for storing a first user profile and a second user profile and a first audio/video program;
a receiver for receiving a request to enable access to a first audio/video program by a second user, said first audio/video program being associated with a first user;
a processor for determining a relationship between said first user and said first user profile, for determining a permission to enable said content for viewing for said first user in response to information within said first user profile, for enabling transmission of said first audio/video program to said second user, for determining a second audio/video program in response to information within said second user profile; and
a transmitter for transmitting said first audio/video program to said second user and data relating to said second audio/video program to said first user.

8. The apparatus of claim 7 wherein said data relating to said second audio/video program is a movie trailer.

9. The apparatus of claim 7 wherein said data relating to said second audio/video program is a program recommendation.

10. The apparatus of claim 7 wherein said second audio/video program is determined in response to a combined analysis of said first user profile and said second user profile.

11. The apparatus of claim 7 wherein said second audio/video program is determined in response to a media purchase made by said second user.

12. The apparatus of claim 7 wherein said second audio/video program is determined in response to a comparison of a viewing history of said first user and a viewing history of said second user.

13. The apparatus of claim 7 wherein the first audio/video program includes data identifying said first user.

14. The apparatus of claim 7 further comprising the step of updating said first user profile and said second user profile with a record of said first audio/video program.
